(19) United States
(12) Patent Application Publication
(10) Pub. No.: US 2015/0290807 A1
(43) Pub. Date: Oct. 15, 2015

(54) SYSTEM AND METHOD FOR GENERATING CONTEXTUAL BEHAVIOURS OF A MOBILE ROBOT EXECUTED IN REAL TIME

(71) Applicant: ALDEBARAN ROBOTICS, PARIS (FR)

(72) Inventors: Victor Paleologue, Paris (FR); Maxime Morisset, Vincennes (FR); Flora Briand, Vanves (FR)

(73) Assignee: ALDEBARAN ROBOTICS, PARIS (FR)

(21) Appl. No.: 14/404,924

(22) PCT Filed: May 30, 2013
(86) PCT No.: PCT/EP2013/061180

§ 371 Date: Mar. 26, 2015

(30) Foreign Application Priority Data
Jun. 1, 2012 (FR) 1255105

(51) Int. Cl. B25J 9/16; G06F 9/44

(52) U.S. Cl. CPC B25J 9/1661; G06F 8/34; B25J 9/1671; G05B 2219/40392

(57) ABSTRACT

A system and a method are provided allowing a user who is not a computer specialist to generate contextual behaviors for a robot that are able to be executed in real time. To this end, a module is provided for editing vignettes into which it is possible to insert graphical representations of behaviors to be executed by the robot while the latter recites texts inserted into bubbles at the same time as expressing emotions. A banner generally having a musical score ensures that the progress of the scenario is synchronized. A module for interpreting the vignette that is installed on the robot allows the identification, compilation, preloading and synchronization of the behaviors, the texts and the music.

The present invention pertains to the field of systems for programming robots. More precisely, it applies to the control of behaviors that are coherent with the context in which the robot, notably in human or animal form, develops, expresses itself and moves on limbs that may or may not be jointed. A robot can be described as humanoid from the instant at which it has certain attributes of the appearance and functionalities of man: a head, a trunk, two arms, possibly two hands, two legs, two feet, etc. One of the functionalities likely to give a robot a quasi-human appearance and behavior is the possibility of providing a high degree of coupling between gestural expression and oral expression. In particular, intuitively arriving at this result allows numerous groups of users to access the programming of humanoid robot behaviors.

The patent application WO2011/003628 discloses a system and a method that responds to this general problem. The invention disclosed by said application allows some of the drawbacks of the prior art to be overcome, which made use of specialized programming languages accessible only to a professional programmer. In the field of virtual agents and avatars, specialized languages in the programming of behaviors at functional or intentional level, independently of physical actions such as FML (Function Markup Language) or at the level of behaviors themselves (which involve a plurality of parts of the virtual character in order to execute a function) such as BML (Behavior Markup Language), remain accessible only to the professional programmer and cannot be integrated with scripts written in everyday language. The invention allows these limitations of the prior art to be exceeded.

However, the invention covered by the cited patent application does not allow the robot to be controlled in real time because it uses an editor that is not capable of sending commands directly to the robot using “streaming”, that is to say that are able to interact in real time with the behaviors of the robot, which may develop according to the development of the environment of said robot. In particular, in the robot of said prior art, a scenario needs to be replayed from the beginning when an unexpected event occurs in the command scenario.

To solve this problem within a context in which the scenarios may be defined by graphical modes inspired by comic strips, the applicant called on the “vignette” concept that is illustrated by numerous passages of the description and that is used in the present application in one of the senses with which it is provided by the dictionary “Trésor de la langue française informatisé” (http://atilf.atilf.fr/dendien/scripts/tlfiv5/visusel.exe?12;s=2774157495;r=1;nat=;sol=1;) “Each of the drawings delimited by a frame in a comic strip”

The present invention makes it possible to solve the problem of the prior art outlined above. In particular, the robot of the invention is equipped with an editor and with a command interpreter that are able to be graphically integrated within vignettes grouping together texts and behaviors from a scenario that are able to be executed as soon as they are sent.

To this end, the present invention discloses a system for editing and controlling at least one scenario, said at least one scenario comprising at least one behavior to be executed and a text to be delivered by at least one robot equipped with motor and speaking capabilities, said system comprising a module for editing said behaviors and texts, said editing module being autonomous in relation to said robot and comprising a submodule for the input of said text to be delivered by the robot and a submodule for managing the behaviors, said system being characterized in that said editing module furthermore comprises a submodule for the representation and graphical association of said at least one behavior and said at least one text in at least one area for the combined display of said at least one behavior and of said at least one text, said combined display area constituting a vignette, said vignette constituting a computer object that can be compiled in order to be executed on said robot.

Advantageously, said at least one vignette comprises at least one graphical object belonging to the group comprising a waiting icon, a robot behavior icon and a text bubble comprising at least one word, said text being intended to be delivered by the robot.

Advantageously, said behavior icon of a vignette comprises a graphical mark that is representative of a personality and/or an emotion of the robot that is/are associated with at least one text bubble in the vignette

Advantageously, said graphical representation of said scenario furthermore comprises at least one banner for synchronizing the progress of the actions represented by said at least one vignette.

Advantageously, the editing and control system of the invention furthermore comprises a module for interpreting said scenarios, said interpretation module being on board said at least one robot and communicating with the editing module in streaming mode.

Advantageously, the module for interpreting said scenarios comprises a submodule for conditioning at least one scenario, said submodule being configured to equip said at least one scenario at the input with an identifier and with a type.

Advantageously, the module for interpreting said scenarios comprises a submodule for compiling said at least one behavior, said submodule being configured to associate the attributes of an object structure with said behavior.

Advantageously, said compilation submodule is configured to cut up said scenarios into subassemblies delimited by a punctuation mark or a line end.

Advantageously, the module for interpreting said scenarios comprises a submodule for controlling the preloading of said at least one behavior into the memory of the robot for execution by said behavior execution module.

Advantageously, the module for interpreting said scenarios comprises a submodule for synchronizing said at least one text to said at least one behavior.

The invention likewise discloses a method for editing and controlling at least one scenario, said at least one scenario comprising at least one behavior to be executed and a text to be delivered by at least one robot equipped with motor and speaking capabilities, said method comprising a step of editing of said behaviors and texts, said editing step being autonomous in relation to said robot and comprising a substep of input of said text to be delivered by the robot and a substep of management of the behaviors, said method being characterized in that said editing step furthermore comprises a substep of representation and graphical association of said at least one behavior and said at least one text in at least one vignette.

The invention likewise discloses a computer program comprising program code instructions allowing the execution of the method of the invention when the program is executed on a computer, said program being configured for allowing the editing of at least one scenario, said at least one scenario comprising at least one behavior to be executed and a text to be delivered by at least one robot equipped with motor and speaking capabilities, said computer program comprising a module for editing said behaviors and texts, said editing module being autonomous in relation to said robot and comprising a submodule for the input of said text to be delivered by the robot and a submodule for managing the behaviors, said computer program being characterized in that said editing module furthermore comprises a submodule for the representation and graphical association of said at least one behavior and said at least one text in at least one vignette.

The invention likewise discloses a computer program comprising program code instructions allowing the execution of the method according to the invention when the program is executed on a computer, said program being configured for allowing the interpretation of at least one scenario, said at least one scenario comprising at least one behavior to be executed and a text to be delivered by at least one robot equipped with motor and speaking capabilities, said computer program comprising a module for interpreting said scenarios, said interpretation module being on board said at least one robot and communicating with an external platform in streaming mode.

Advantageously, the module for interpreting said scenarios comprises a submodule for compiling said at least one behavior, said submodule being configured to associate the attributes of an object structure with said behavior.

Advantageously, the module for interpreting said scenarios comprises a submodule for controlling the preloading of said at least one behavior into the memory of the robot for execution by said behavior execution module (460).

Advantageously, the module for interpreting said scenarios comprises a submodule for synchronizing said at least one text to said at least one behavior.

The invention allows the creation of behavior libraries and the easy insertion thereof into a script for scenes played by the robot. The behaviors are modeled by graphical vignettes representing, in each vignette, the gestural and emotional behaviors of the robot, and its words and the environmental elements (music, images, words of other characters, etc.). This scenario creation interface is intuitive and allows the user to easily create complex scenarios that will be able to be adapted in real time.

The invention likewise provides an appropriate complement to the French patent application n° 09/53434 relating to a system and a method for editing and controlling the behaviors of a mobile robot from the applicant. Said application affords means for having behaviors executed by a robot, said behaviors being able to be controlled either using a specialized script language that is accessible to programmers or graphically by calling on preprogrammed libraries that can be selected and inserted into a series of behavior boxes connected by events. The invention also allows simplification of the interface for programming the behaviors of the robot.

The invention will be better understood and the various features and advantages thereof will emerge from the description that follows for a plurality of exemplary embodiments and from the appended figures, in which:

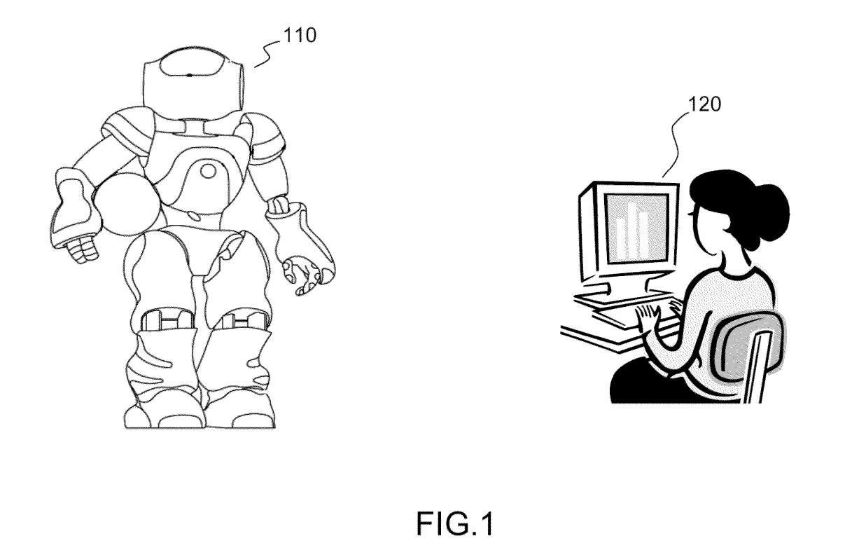

FIG. 1 shows the physical architecture of a system for implementing the invention according to a plurality of embodiments;

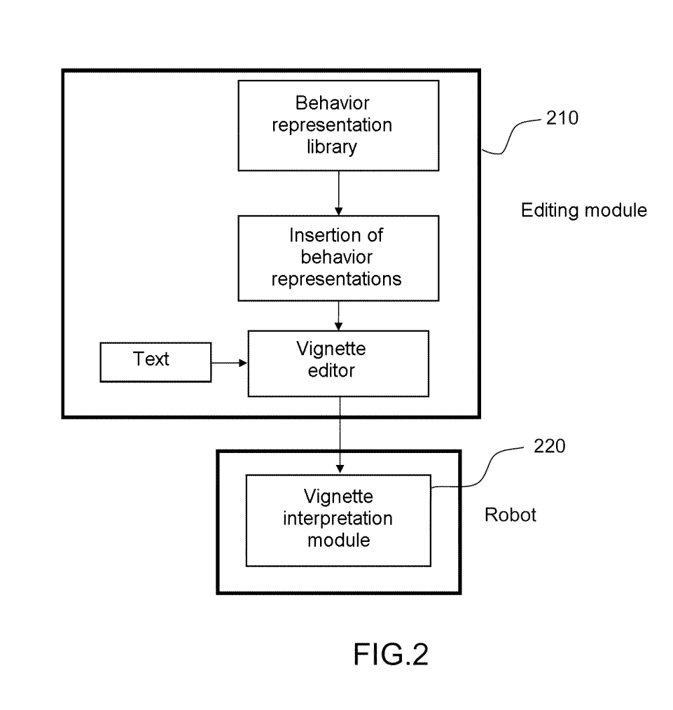

FIG. 2 shows a general flowchart for the processing operations according to a plurality of embodiments of the invention;

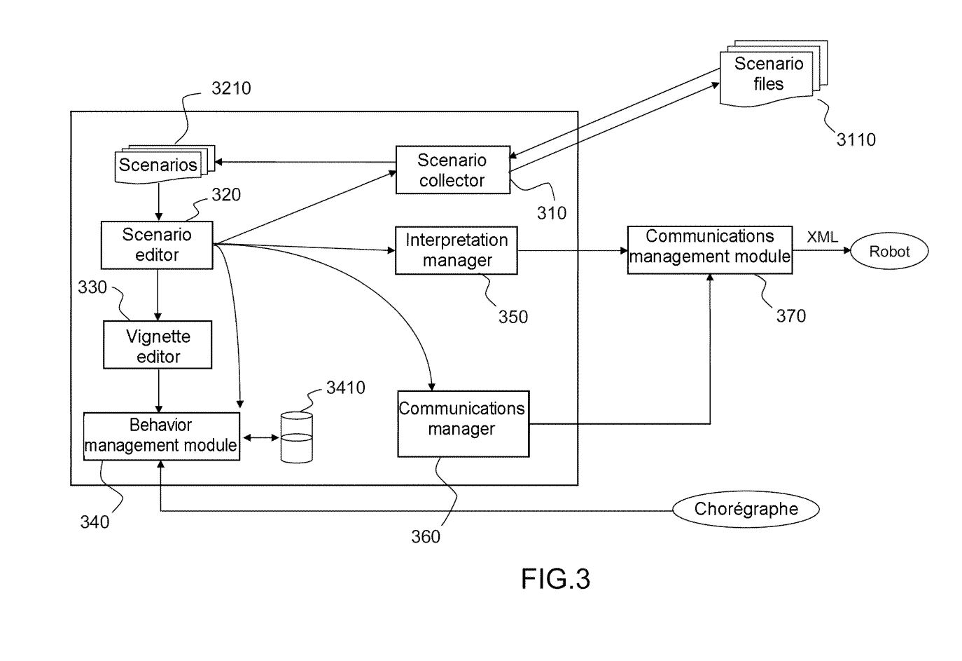

FIG. 3 shows a flowchart for the processing operations performed in a command editing module according to a plurality of embodiments of the invention;

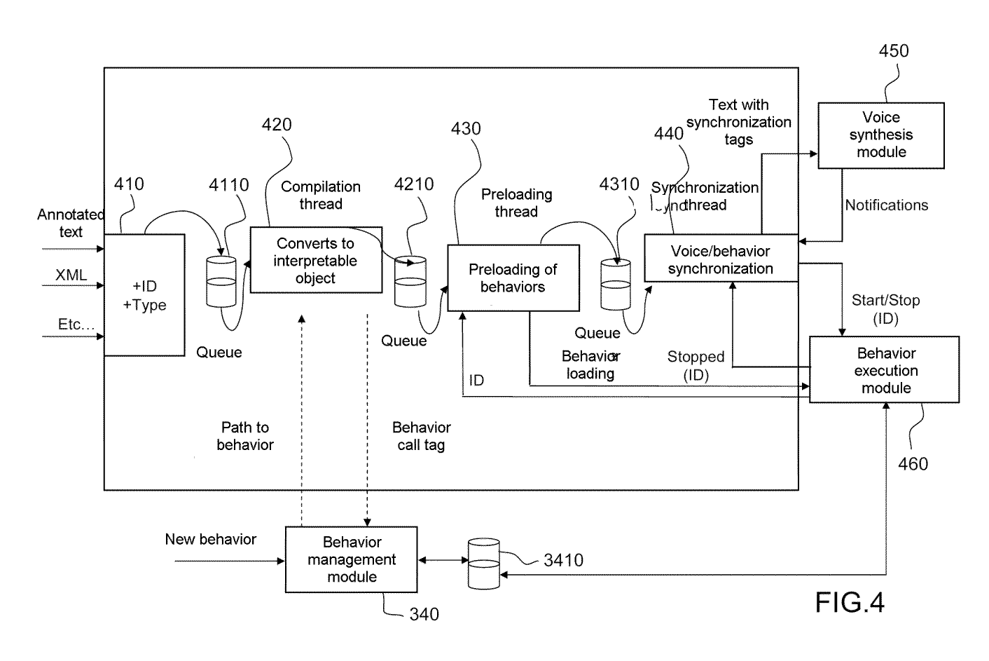

FIG. 4 shows a flowchart for the processing operations performed in a command interpretation module according to a plurality of embodiments of the invention;

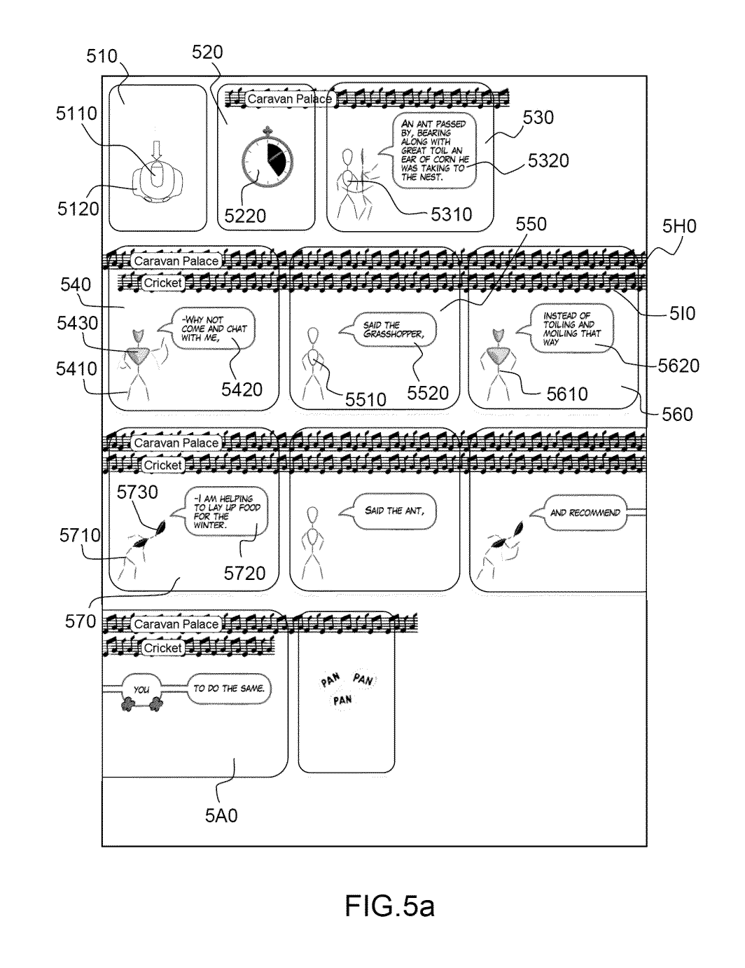

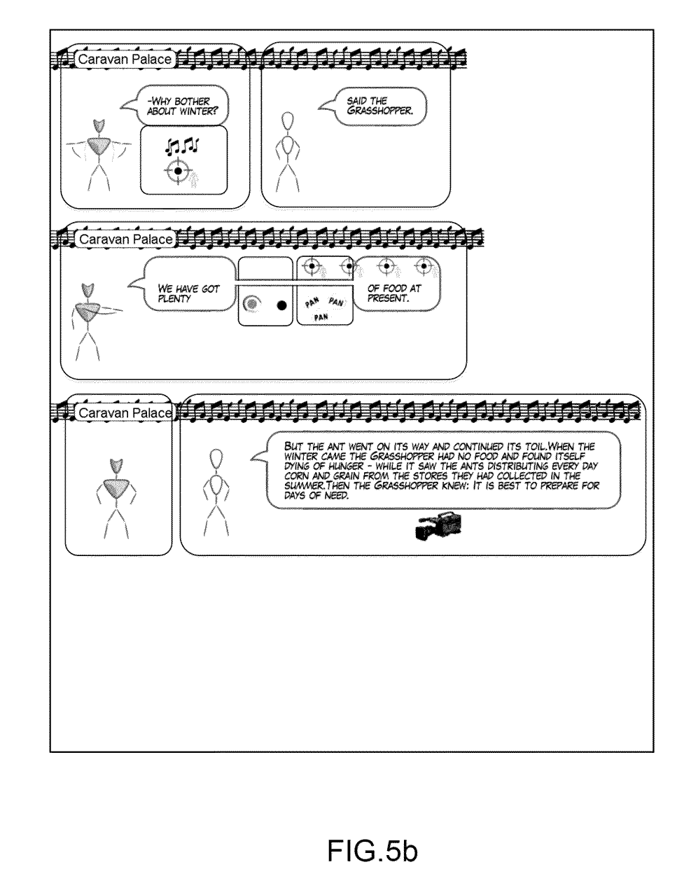

FIGS. 5a and 5b show vignettes constituting a scenario executed by a robot in an embodiment of the invention.

FIG. 1 shows the physical architecture of a system for implementing the invention according to a plurality of embodiments.

A humanoid robot 110 is shown in the figure in an embodiment of the invention. Such a robot has been disclosed notably in the patent application WO2009/124951 published on Oct. 15, 2009. This platform has been taken as a basis for the improvements that have led to the present invention. In the remainder of the description, said humanoid robot can be indiscriminately denoted by this generic name or under its trademark NAO™, without the generality of the reference being modified.

Said robot comprises approximately two dozen electronic boards for controlling sensors and actuators that drive the joints. The electronic control board has a commercial microcontroller. This may be a DSPIC™ from the Microchip company, for example. This is a 16-bit MCU coupled to a DSP. Said MCU has a looped servocontrol cycle of 1 ms.

The robot may likewise have other types of actuators, notably LEDs (light-emitting diodes), the color and intensity of which can translate the emotions of the robot. The latter may likewise have other types of position sensors, notably an inertial unit, FSRs (ground pressure sensors), etc.

The head has the intelligence of the robot, notably the board that executes the high-level functions that allow the robot to accomplish missions that are assigned to it, notably, within the context of the present invention, for executing scenarios written by a user who is not a professional programmer. The head may likewise have specialized boards, notably for processing words or vision or likewise for processing service inputs/outputs, such as the encoding necessary to open a port in order to set up remote communication on a wide area network WAN. The processor of the board may be a commercial x86 processor. Preferably, a low-consumption processor will be chosen, for example an ATOM™ from the Intel company (32 bits, 1600 MHz). The board likewise has a set of RAM and flash memories. Said board likewise manages the communications of the robot with the outside (behavior server, other robots, etc.), normally on a WiFi or WiMax transmission layer, possibly on a public mobile data communication network with standard protocols possibly encapsulated in a VPN. The processor is normally driven by a standard OS, which allows the use of the usual high-level languages (C, C++, Python, etc.) or the specific artificial intelligence languages such as URBI (specialized programming language for robotics) for programming high-level functions.

The robot 110 will be able to execute behaviors for which it will have been able to have been programmed in advance, notably by means of a code generated according to the invention disclosed in French patent application n° 09/53434, which has already been cited, said code having been written by a programmer in a graphical interface. Said behaviors may likewise have been arranged in a scenario created by a user who is not a professional programmer, using the invention disclosed in the patent application WO2011/003628, which has likewise already been cited. In the first case, these may be behaviors joined to one another according to relatively complex logic in which the sequences of behaviors are coordinated by the events that occur in the environment of the robot. In this case, a user, who must have a minimum of programmer skills, can use the Chorégraphe™ studio, the main modes of operation of which are described in the cited application. In the second case, the progression logic for the scenario is not adaptive in principle.

In the present invention, a user who is not a professional programmer, 120, is able to produce a complex scenario comprising sets of behaviors comprising gestures and various movements, emissions of audio or visual signals, words forming questions and answers, said various elements all being graphically represented by icons on a sequence of vignettes (see FIG. 5). As will be seen later, the vignettes constitute the interface for programming the story that will be played out by the robot.

FIG. 2 shows a general flowchart for the processing operations according to a plurality of embodiments of the invention.

In order to create scenarios according to the procedures of the invention, the PC 120 comprises a software module 210 for graphically editing the commands that will be given to the robot(s). The architecture and operation will be explained in detail in connection with FIG. 3.

The PC communicates with the robot and sends it the vignettes that will be interpreted in order to be executed by the software module for interpreting the vignettes 220. The architecture and operation of said module 220 will be explained in detail in connection with FIG. 4.

The PC of the user communicates with the robot via a wired interface or by radio, or even both if the robot and the user are situated in remote locations and communicate over a wide area network. The latter case is not shown in the figure but is one of the possible embodiments of the invention.

Although the embodiments of the invention in which a plurality of robots are programmed by a single user or in which a robot is programmed by a plurality of users or a plurality of robots are programmed by a plurality of users are not shown in the figure, these cases are entirely possible within the scope of the present invention.

FIG. 3 shows a flowchart for the processing operations performed in a command editing module according to a plurality of embodiments of the invention.

The editing module 210 comprises a scenario collector 310 that is in communication with scenario files 3110. The scenarios can be visually displayed and modified in a scenario editor 320 that may simultaneously have a plurality of scenarios 3210 in memory. A scenario generally corresponds to a text and is constituted by a succession of vignettes.

In order to implement the invention, the editing module comprises a vignette editor 330. The vignette has commands for elementary behavior inserted into it that are represented by an icon. Said behaviors will be able to be reproduced by the robot. It is likewise possible to insert a text (inserted into a bubble, as explained in connection with FIG. 5). Said text will likewise be reproduced by the robot vocally.

The editing module normally receives as an input a text that defines a scenario. Said input can be made directly using a simple computer keyboard or by loading a file of text type (*.doc, *.txt or the like) or an html file (possibly denoted by its URL address) into the system. Said files may likewise be received from a remote site, for example by means of a messaging system. In order to perform this reading, the system or the robot is equipped with a synthesis device that is capable of interpreting the text from the script editor in order to produce sounds, which may be either words in the case of a humanoid robot or sounds representing the behavior of an animal. The audio synthesis device can likewise reproduce background sounds, for example ambient music that, possibly, can be played on a remote computer.

The reading of a story can be started upon reception of an event external to the robot, such as:
reception of an electronic message (e-mail, SMS, telephone call or other message);
a home-automation event (for example someone opening the door, someone switching on a light or another event),
an action by a user, which may be touching a touch-sensitive area of the robot (for example its head), a gesture or a word, which are preprogrammed to do this.

Behavior commands are represented in a vignette by an icon illustrating said behavior. By way of nonlimiting example, behavior commands can generate:
movements by the limbs of the robot (raising an arm, movement, etc.) that will be reproduced by the robot;
light effects that will be produced by the LEDs positioned on the robot;
sounds that will be synthesized by the robot;
voice settings (speed, voice, language, etc.) for regulating the modes of recitation of the text that will be reproduced by the robot.

The behavior commands can be inserted into a behavior management module 340 by sliding a chosen behavior control icon from a library 3410 to a vignette situated in the vignette editing module 330. The editing module 330 likewise allows a text to be copied and pasted. The interpretation module on board the robot can interpret an annotated text from an external application. Advantageously within the scope of the present invention, the external application may be a Chorégraphe™ box, said application being the software for programming the NAO robot that is described notably in French patent application n° 09/53434, which has already been cited. Said annotated texts may likewise be web pages, e-mails, short instant messages (SMS), or come from other applications provided that the module 330 has the interface that is necessary in order to integrate them.

The editing module 210 communicates with the robot via a communications management module 370 that conditions XML streams sent on the physical layer by means of which the robot is connected to the PC. An interpretation manager 350 and a communications manager 360 complete the editing module. The interpretation manager 350 is used to begin the interpretation of the text, to stop it and to provide information about the interpretation (passage in the text at which the interpretation is rendered, for example). The communications manager 360 is used to connect to a robot, to disconnect and to receive information about the connection (status of the connection or untimely disconnection, for example).

FIG. 4 shows a flowchart for the processing operations performed in a command interpretation module according to a plurality of embodiments of the invention.

The XML streams from the editing module 210 and other streams, such as annotated text from an e-mail box or a mobile telephone, are equipped with an identifier (ID) and a type by a submodule 410 of the vignette interpretation module 220. The identified and typed streams in the queue 4110 are then converted into interpretable objects such as behaviors by a compilation thread 420. A reference to a behavior that is not necessarily explicit out of context is replaced with a synchronization tag coupled to a direct reference to the behavior by means of the path to the location at which it is stored. Said thread exchanges with the behavior management module 340 of the vignette editor 210. These exchanges allow the detection of the references to behaviors in the text. Since the compilation thread does not know the tags that might correspond to a behavior, it first of all needs to request all these tags from the behavior management module in order to be able to detect them in the text. Next, when it detects a tag in the text, it asks the behavior management module what the behavior that corresponds to said tag is (for example “lol”). The behavior management module answers it by providing it with the path to the corresponding behavior (“Animations/Positive/Laugh”, for example). These exchanges take place in synch with the compilation thread.

When the compilation thread detects an end of a sentence (which may be defined by punctuation marks, line ends, etc.), it sends the sentence to the queue 4210. In order to allow faster execution of the scenarios, there is provision for a thread 430 for preloading, to a queue 4310 from the queue 4210, the behaviors whose address in the form of a path to the behavior is sent directly to the behavior execution module 460. Thus, the call programmed by its identifier ID will be immediate as soon as, according to the scenario, a behavior needs to be executed. To do this, the execution module then preloads the behavior and returns the unique ID of the instance of the behavior that is ready to be executed. Thus, the execution module will immediately be able to execute said behavior as soon as it needs to, the synchronization of the text and of the behaviors therefore being greatly improved.

A synchronization thread 440 allows for the text spoken by the voice synthesis module 450 and the behaviors executed by the behavior execution module 460 to be linked in time. The text with synchronization tags is sent to the voice synthesis module 450, while the behavior identifiers ID corresponding to the tempo of the synchronization are sent to the behavior execution module 460, which makes the preloaded behavior calls corresponding to the IDs of the behaviors to be executed.

The organization of the processing operations in said vignette interpretation module allows the realization of the loading and the streamed execution of the scenarios that are to be executed by the robot. This allows much more fluid interactions between the user and the robot, the user being able, by way of example, to write the scenario as he goes along and to transmit it to the robot when he wishes, said robot being able to execute the sequences of the scenario almost immediately after they are received.

FIGS. 5a and 5b show vignettes constituting a scenario executed by a robot in an embodiment of the invention.

Purely by way of example, the scenario in the figure comprises 16 vignettes. A scenario may comprise any number of vignettes. In the 1^{st} vignette 510, the robot waits for its tactile sensor 5110 situated on its head 5120 to be actuated. In the 2^{nd} vignette 520, the robot waits for a determined period 5520 after the action of touch on the tactile sensor to have elapsed. In the 3^{rd} vignette 530, the robot is a first character, the narrator 5310, and executes a first behavior symbolized by the graphical representation of the character, which involves performing a rotation while reading the text written in the bubble 5320 in a voice characterizing said first character. In the 4^{th} vignette 540, the robot is a second character 5410 (in the scenario of the example, a grasshopper symbolized by a graphical symbol 5430) and executes a second behavior symbolized by the graphical representation of the character, which involves swinging its right arm upwards while reading the text written in the bubble 5420 in a different voice than that of the narrator and characterizing said second character. In the 5^{th} vignette 550, the narrator robot is in a static position represented by the character 5510 and reads the text written in the bubble 5520.

In the 6^{th} vignette 560, the grasshopper robot 5610 is likewise in a static position represented in the same way as in 5510 and reads the text written in the bubble 5620. In the 7^{th} vignette, 570, the robot is a third character (in the scenario of the example, an ant symbolized by a graphical symbol 5730) and delivers a text 5720.

Thus, in the scenario example illustrated by the figure, three different characters 5310, 5410 and 5710 intervene. This number of characters is not limited.

The number of behaviors and emotions is not limited either. The behaviors can be taken from a base of behaviors 3410, which are created in Chorégraphe, the professional behavior editor or other tools. They can possibly be modified in the behavior management module 340 of the editing module 210 that manages the behavior base 3410. Within the scope of implementation of the present invention, a behavior object is defined by a name, a category, possibly a subcategory, a representation, possibly one or more parameters, possibly the association of one or more files (audio or other). A vignette may comprise a plurality of bubbles, or a bubble comprising a minimum of one word, as illustrated in the vignette 5A0.

A scenario may likewise be characterized by a banner 5H0 that may or may not correspond to a musical score, said score being synchronized to the tree structure of the vignettes/bubbles. Said synchronization facilitates the interweaving of a plurality of levels of vignettes whose execution is conditional. A plurality of banners can proceed in parallel as illustrated in the figure by the banner 5I0.

The texts can be read in different languages, using different prosodies (speed, volume, style, voice, etc.). The variety of behaviors and emotions that may be used in the system of the invention is not limited. By way of example, the voice may be a male, female or child's voice; the tone may be more or less low or high pitched; the speed may be more or less rapid; the intonation may be chosen depending on the emotion that the robot is likely to feel on the basis of the text of the script (affection, surprise, anger, joy, reproof, etc.). Gestures to accompany the script may be, by way of example, movement of the arms upwards or forwards; stamping a foot on the ground; movements of the head upwards, downwards, to the right or to the left, according to the impression that needs to be conveyed in connection with the script, etc.

The robot is able to interact with its environment and its interlocutors in likewise very varied fashion: words, gestures, touch, emission of light signals, etc. By way of example, if the robot is equipped with light emitting diodes (LEDs), these will be able to be actuated in order to translate strong emotions “felt” by the robot when reading the text or to generate blinking suited to the form and speed of delivery.

As illustrated in vignettes 510 and 520, some commands may be commands for interruption and waiting for an external event, such as a movement in response to a question asked by the robot.

Some commands may be dependent on the reactions of the robot to its environment, for example picked by a camera or ultrasonic sensors.

The examples described above are provided by way of illustration of embodiments of the invention. They do not in any way limit the field of the invention, which is defined by the claims that follow.

1. A system for editing at least one user to edit and control at least one scenario, said at least one scenario comprising at least one behavior to be executed and a text to be delivered by at least one robot equipped with motor and speaking capabilities, said system comprising a module for editing said behaviors and texts, said editing module being autonomous in relation to said robot and comprising a submodule for the input of said text to be delivered by the robot, a submodule for editing at least one scenario associating said at least one behavior and said at least one text, and a submodule for managing the behaviors, said submodule for editing at least one scenario being capable of executing a function for the representation and graphical association of said scenario comprising said at least one behavior and said at least one text in at least one area for the combined display of said scenario comprising said at least one behavior and said at least one text, wherein said combined display area constitutes a vignette, said vignette constituting a computer object that can be compiled by a compilation thread in order to be executed on said robot by a behavior execution module, said scenario being able to be modified without stopping the behavior execution module, by the action of the user in the scenario editing submodule.

2. The editing and control system of claim 1, wherein at least one vignette comprises at least one graphical object belonging to the group comprising a waiting icon, a robot behavior icon and a text bubble comprising at least one word, said text being intended to be delivered by the robot.

3. The editing and control system of claim 2, wherein said behavior icon of a vignette comprises a graphical mark that is representative of a personality and/or an emotion of the robot that is/are associated with at least one text bubble in the vignette.

4. The editing and control system of claim 2, wherein said graphical representation of said scenario furthermore comprises at least one banner for synchronizing the progress of the actions represented by said at least one vignette.

5. (canceled)

6. The editing and control system of claim 1, configured to execute a function for conditioning at least one scenario, to equip said at least one scenario at the input with an identifier and with a type.

7. (canceled)

8. The editing and control system of claim 1, wherein said compilation thread is configured to cut up said scenarios into subassemblies delimited by a punctuation mark or a line end.

9. The editing and control system of claim 1, further configured to execute a function for controlling the preloading of said at least one behavior into the memory of the robot for execution by said behavior execution module.

10. The editing and control system of claim 1, further configured to execute a function for synchronizing said at least one text to said at least one behavior.

11. A method for at least one user to edit and control at least one scenario, said at least one scenario comprising at least one behavior to be executed and a text to be delivered by at least one robot equipped with motor and speaking capabilities, said method comprising a step of editing of said behaviors and texts, said editing step being autonomous in relation to said robot and comprising a substep of input of said text to be delivered by the robot, a substep for editing at least one scenario associating said at least one behavior and said at least one text, and a substep for managing the behaviors, said substep for editing at least one scenario executing a function of representation and graphical association of said at least one behavior and said at least one text in at least one area for the combined display of the said at least one behavior and of said at least one text, wherein said combined display area constitutes a vignette, said vignette constituting a computer object that can be compiled by a compilation thread in order to be executed on said robot in the course of a behavior execution step, said scenario being able to be modified without stopping the behavior execution step, by the action of the user in the scenario editing substep.

12. A computer program comprising program code instructions, allowing the execution of the method as claimed in claim 11 when the program is executed on a computer, said program being configured for allowing the editing of at least one scenario, said at least one scenario comprising at least one behavior to be executed and a text to be delivered by at least one robot equipped with motor and speaking capabilities, said computer program comprising a module for editing said behaviors and texts, said editing module being autonomous in relation to said robot and comprising a submodule for the input of said text to be delivered by the robot, a submodule for editing at least one scenario associating said at least one behavior and said at least one text, and a submodule for managing the behaviors, said submodule for editing at least one scenario being capable of executing a function for the graphical representation and presentation of said at least one behavior and said at least one text in at least one area for the combined display of said at least one behavior and said at least one text, said combined display area constituting a vignette, said vignette constituting a computer object that can be compiled in order to be executed on said robot by a behavior execution module, said scenario being able to be modified without stopping the behavior execution module, by the action of the user in the scenario editing submodule.

13.-16. (canceled)
